(19) United States
(12) Patent Application Publication
(10) Pub. No.: US 2025/0392463 A1
(43) Pub. Date: Dec. 25, 2025

(54) MULTI-PARTY TOKEN-BASED AUTHORIZATION FOR A DATA STORAGE SYSTEM

(71) Applicant: International Business Machines Corporation, Armonk, NY (US)

(72) Inventors: William McKenna, Naperville, IL (US); Mark Duane Seaborn, Algonquin, IL (US); Shikha Shree, Chicago, IL (US); Akila Srinivasan, Carpentersville, IL (US)

(21) Appl. No.: 18/751,614

(22) Filed: Jun. 24, 2024

(51) Int. Cl. H04L 9/32; G06F 21/62; H04L 9/00

(52) U.S. Cl. CPC H04L 9/3213; G06F 21/6218; H04L 9/006; G06F 2221/2141

(57) ABSTRACT

Examples described herein provide a computer-implemented method that includes receiving, at a token generation service, a contract token request from a data non-owner, the contract token request indicating a condition of an agreement between the data non-owner and a data owner that owns data stored in a data storage system. The method further includes generating, by the token generation service, a contract token based on the contract token request, the contract token including an attribute that defines the condition of the agreement between the data non-owner and the data owner. The data storage system enables the data owner to execute an operation on the data based at least in part on the contract token.

### BACKGROUND

The present disclosure relates to computing environments, and more specifically, to multi-party token-based authorization for a data storage system.

Some computing environments, like z/Architecture-based computing environments from International Business Machines, provide private, secure, and resilient hybrid multicloud computing capabilities. Such computing environments provide for storing data, which may be accessible by an owner of the data or by others.

### SUMMARY

According to an embodiment, a computer-implemented method is provided. The method includes receiving, at a token generation service, a contract token request from a data non-owner, the contract token request indicating a condition of an agreement between the data non-owner and a data owner that owns data stored in a data storage system. The method further includes generating, by the token generation service, a contract token based on the contract token request, the contract token including an attribute that defines the condition of the agreement between the data non-owner and the data owner. The data storage system enables the data owner to execute an operation on the data based at least in part on the contract token.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment, according to an embodiment;

FIG. 2A illustrates a block diagram of an environment for multi-party token-based authorization for a data storage system, according to an embodiment;

FIG. 2B illustrates a block diagram of an environment for multi-party token-based authorization for a data storage system, according to an embodiment;

FIG. 3 illustrates a flow diagram of a method for multi-party token-based authorization for a data storage system, according to an embodiment; and

FIG. 4 illustrates a block diagram of an environment for multi-party token-based authorization for a data storage system, according to an embodiment.

### DETAILED DESCRIPTION

One or more embodiments described herein provide for multi-party token-based authorization for a data storage system (DSS). Data and/or associated metadata stored in a DSS often has an owner (in the form of a user or users within an account with the DSS) responsible for it. Data owners often have strict control over their data and the permissions that govern access to the data. This data may also have one or more non-owner parties (referred to as data non-owners) that have a claim as to how the data or metadata are managed.

As used herein, “data” refers to any information retained or stored in a DSS, which may be any suitable electronic storage system. A “data owner” (“DO”) is an individual or organization that is responsible for the administration of data stored in a DSS. A “data non-owner” (“DNO”) is an individual or organization, other than a data owner, who has influence over data that is not directly owned or administered by the DNO. A “token generation service” is an entity that generates or issues tokens.

It can be difficult for data non-owners to provide governance or approbate actions on data or metadata owned by the separate entity (e.g., the data owner).

One or more embodiments described herein address these and other shortcomings by describing a multi-domain security system where multiple parties (e.g., a data owner and a data non-owner) can form an agreement over the administration of data. This is accomplished through generation of a set of tokens having a signed set of attributes viewable by each individual party and secured from modification. These tokens allow a data non-owner to govern a set of additional actions, which are specified as an attribute within a token, that can be executed by the data owner on its data. These actions are usable by the data owner through the application of the token on the resource (e.g., the DSS).

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

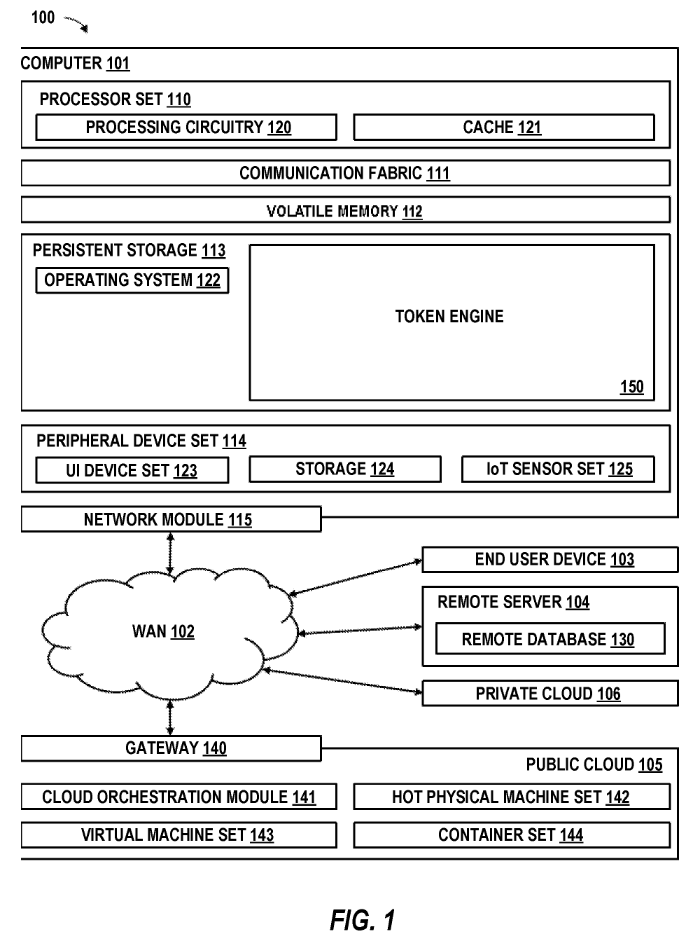

FIG. 1 illustrates a computing environment 100, according to an embodiment. Computing environment 100 contains an example of an environment for the execution of at least some of the computer code involved in performing the inventive methods, such as a token engine 150 for multi-party token-based authorization for a data storage system. In addition to the token engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the token engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the token engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the token engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

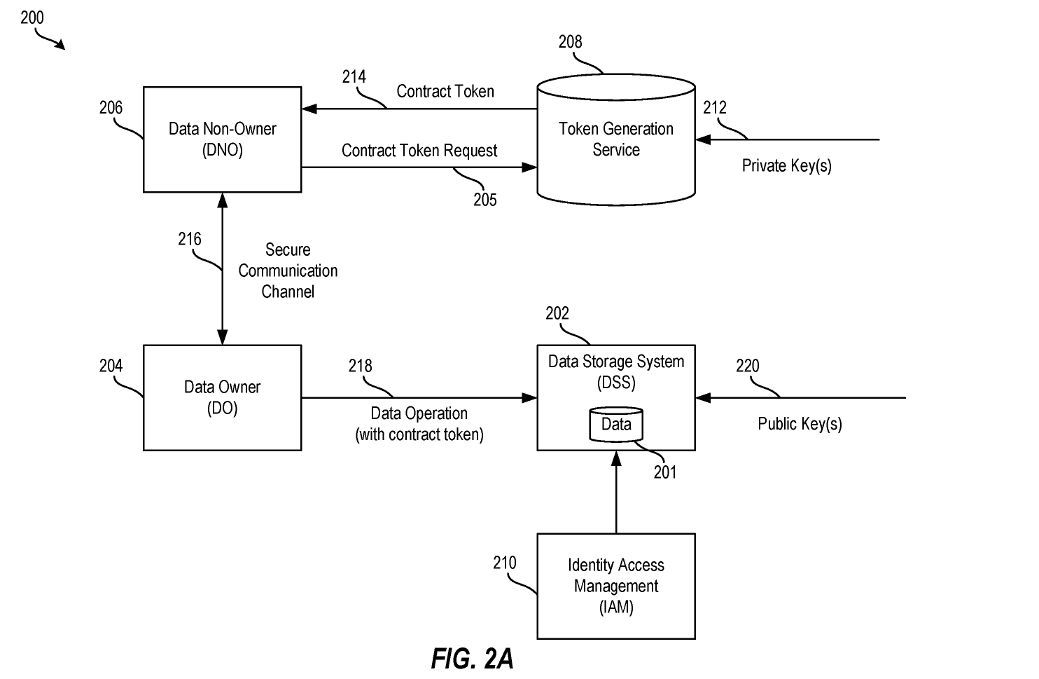

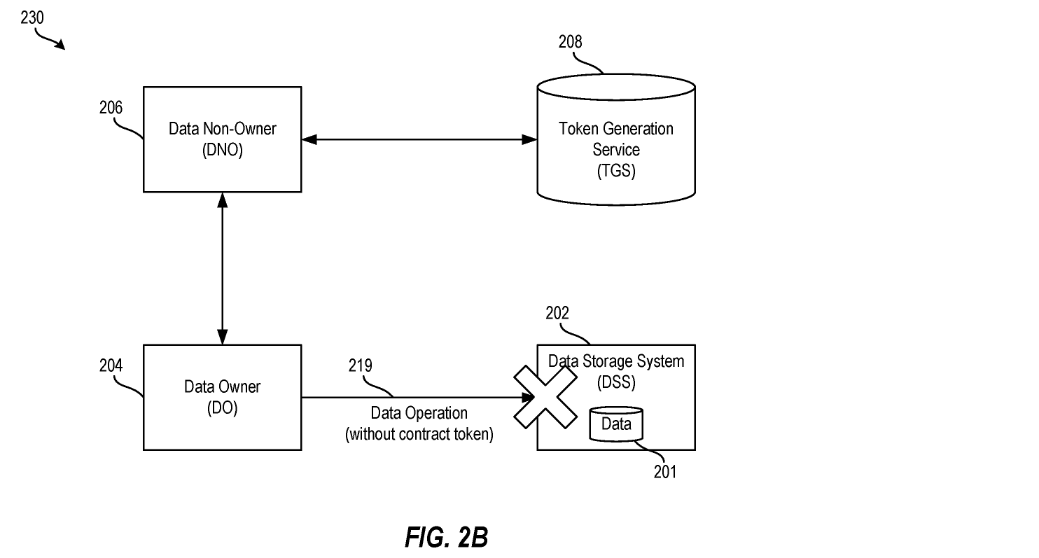

FIGS. 2A and 2B are now described together. These figures depict environments for multi-party token-based authorization for a DSS 202, according to embodiments. In particular, FIG. 2A depicts a block diagram of an environment 200 for multi-party token-based authorization for a data storage system, according to an embodiment. FIG. 2B depicts a block diagram of an environment 230 for multi-party token-based authorization for a data storage system, according to an embodiment.

According to one or more embodiments, data owner (DO) 204 stores data 201 (which may include metadata) in the DSS 202, and data non-owner (DNO) 206 is responsible for the administration of the data 201. That is, the DO 204 and the DNO 206 establish separate domains of authority over the data 201. For example, the DNO 206 is responsible for oversight of some aspects of the use and modification of the data 201 by the DO 204 but does not directly administer/control the data. This is referred to as a claim to on the data 201 by the DNO 206. Instead, data operations are executed by the DO 204 and not by the DNO 206. The DO 204 retains identity and access permissions from an identify and access management (IAM) system 210 associated with the DSS 202.

A token generation service 208 generates/creates contract tokens (e.g., contract token 214) that codify an agreement between the DO 204 and the DNO 206. For example, the DO 204 and DNO 206 agree on conditions (e.g., a period of time in which the DO 204 can modify or delete data, a range of data that can be modified or deleted, and/or the like, including combinations and/or multiples thereof). Those conditions are codified as attributes in a contract token 214 generated by the token generation service 208. Attributes are the actions that the DO 204 may perform on the data 201 (e.g., delete some or all of the data 201, modify some or all of the data 201, a time period during with the data operation(s) can be performed, a number of times the data operation(s) can be performed, and/or the like, including combinations and/or multiples thereof). Private key(s) 212 are generated and used to sign the contract token 214. According to one or more embodiments, the contract token 214 is provided from the token generation service 208 to the DNO 206 and not the DO 204. According to one or more embodiments, the DNO 206 provides the contract token 214 to the DO 204 via a link, such as a secure communication channel 216. The secure communication channel 216 is any suitable secure/encrypted communication protocol, such as hypertext transfer protocol secure (HTTPS), secure socket layer (SSL), and/or the like, including combinations and/or multiples thereof.

The DSS 202 not only stores the data 201 but also serves as a validation authority for the contract token 214 (and other contract tokens) and executes data operations on the data 201 as defined by the contract token 214. That is, the DSS 202 enables the DO 204 to interact with the data 201 (e.g., perform a data operation 218) in accordance with the agreement between the DO 204 and the DNO 206 as defined by the contract token 214. The DSS 202 uses a public key(s) 220 to validate the contents of the contract token 214 against alteration. Then, knowing that the contract token 214 is valid, alteration of the data 201 can take place according to the conditions defined in the contract token 214. Examples of the data operation 218 include reading data, writing data, modifying data, deleting data, and/or the like, including combinations and/or multiples thereof. The data operation 218 is controlled according to the terms of the contract token 214. That is, the data operation 218 is limited to the terms of the agreement between the DO 204 and the DNO 206 as codified in the contract token 214.

With reference to FIGS. 2A and 2B, consider the following example scenarios of a token generation workflow. The DO 204 wants to execute an operation(s) (e.g., data operation 218) on the data 201 stored in the DSS 202, and the operation falls under the domain of authority of the DNO 206. If the DO 204 attempts to perform data operation 219 without a contract token that is prohibited without a contract token 214, the DSS 202 denies the data operation 218 (see FIG. 2B). It should be appreciated that the DO 204 may perform some data operations (e.g., read data, write new data, and/or the like, including combinations and/or multiples thereof) while being prohibited from performing other data operations (e.g., modify existing data, delete data, and/or the like, including combinations and/or multiples thereof). For example, the DO 204 may want to delete data that is older than a threshold period (e.g., older than one year) that has been backed up to another data storage system (not shown), which may be more suitable for longer term storage of older data. However, the DNO 206 has a claim to the operation(s) that the DO 204 can execute on the data 201. In such cases, the DSS 202 prevents the data operation 218 because the data operation 218 is not allowed, as shown in FIG. 2B. In the case where the DO 204 desires to perform an operation that is otherwise prohibited, the DO 204 can negotiate with the DNO 206 to be able to perform such operations.

To do this, the DO 204 can establish communication (e.g., via the secure communication channel 216) with the DNO 206, which has claims on the data 201, to seek permission for the desired operation(s) (e.g., modify existing data, delete data, and/or the like, including combinations and/or multiples thereof). More particularly, the DO 204 and the DNO 206 negotiate whether the DO 204 can perform the desired operation(s). If the DO 204 and the DNO 206 agree to the DO 204 performing the desired operation(s), the DNO 206 sends a contract token request 205 to the token generation service 208. The contract token request 205 indicates a condition of an agreement between the DNO 206 and the DO 204 that owns the data 201 stored in the DSS 202. The terms of the agreement can be codified by the token generation service 208 into the contract token 214, which is then sent back to the DNO 206. More particularly, the DNO 206 retrieves the contract token 214, validates attributes of the contract token 214, and securely distributes the contract token 214 to the DO 204, such as via the secure communication channel 216.

According to one or more embodiments, the DO 204 validates the attributes of the contract token 214 and executes the data operation 218 using the contract token 214. That is, the contract token 214 can be used by the DO 204 to perform the data operation 218 (e.g., data operation with contract token) on the data 201 stored in the DSS 202. When the DSS 202 receives the data operation 218, the DSS 202 validates both that the DO 204 has permission to execute the data operation 204 based on a preexisting permissions policy (which defines what actions the DO 204 can and cannot perform on the data 201) and based on whether the DO 204 has permission to execute the requested data operation based on the attributes of the contract token 214. In this way, the contract token 214 provides the DO 204 to be able to perform data operations that are otherwise prohibited, such as by the preexisting permissions policy.

According to one or more embodiments, the DSS 202 can arbitrate specific domains of authority over the data 201. For example, the DO 204 retains the ability to administer permissions within its account and can cede or assign domains of authority to other entities (e.g., a third party). The DNO 206 is an entity that can be given a domain of authority, such as to oversee and influence the data operations performed by the DO 204. The DO 204 retains final decision making authority on using or applying operations that are authorized by the contract token 214. That is, just because the DO 204 has the authority to perform a particular data operation as defined within the contract token 214, the DO 204 can decide whether to perform that particular data operation. The DNO 206 cannot directly modify the data 201 (and/or any associated metadata).

According to one or more embodiments, the token generation service 208 can create contract tokens that permit the DO 204 to take certain actions that are otherwise restricted, as allowed according to a domain of authority of the DNO 206. The contract tokens can allow direct access to the data 201 by the DO 204 and/or can provide a temporary state where an elevated set of permissions can be used. According to one or more embodiments, the DNO 206 can terminate the use of the contract token 214 by the DO 204. According to one or more embodiments, the contract token 214 can be implemented using a Java web token or another suitable mechanism.

According to one or more embodiments, the following attributes can be defined in the contract token 214 as codified agreements between the DO 204 and the DNO 206: file prefix, name of data or metadata, type of source (e.g., object, bucket, data block, etc.), duration a condition of the contract token is active, date/time the contract token expires, identification of party who can execute operations using the contract token, number of uses of the contract token (e.g., one-time use), and/or the like, including combinations and/or multiples thereof.

According to one or more embodiments, the DSS 202 can provide additional layers of security against internal and/or external malicious user attacks on the data 201. For example, the DSS 202 can establish relationships with multiple token generation services that overlap permission on the same data, thus requiring the use of multiple tokens to allow a particular data operation to be performed. Such an approach of requiring multiple points of intrusion enhances security against malicious users gaining access. Such an approach may also be useful where multiple data non-owners have an interest in the data, whereby authorization much be received from each of the DNOs to modify the data, according to one or more embodiments.

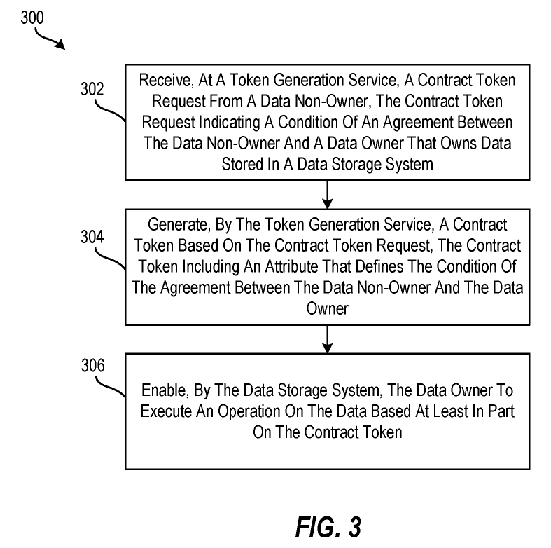

FIG. 3 illustrates a flow diagram of a method 300 for multi-party token-based authorization for a data storage system, according to an embodiment. The method 300 can be performed by any suitable computing system, device, or environment, such as those described herein. The method 300 is now described with reference to the computing environment 100 and/or the environments 200, 230 but is not so limited. According to one or more embodiments, the method 300 can be implemented using the token engine 150, which may be embodied in the computer 101 as shown, in the public cloud 105, and/or in another suitable device, system, or environment separate from the computer 101 and the public cloud 105.

At block 302, the token generation service 208 receives contract token request 205 from DNO 206. The contract token request 205 indicates a condition of an agreement between the DNO 206 and the DO 204 that owns the data 201 stored in the DSS 202. According to one or more embodiments, the DNO 206 and the DO 204 communicate via the secure communication channel 216.

At block 304, the token generation service 208 generates the contract token 214 based on the contract token request 205. The contract token 214 includes an attribute (as described herein) that defines the condition of the agreement between the DNO 206 and the DO 204. According to one or more embodiments, the attribute is viewable by each of the DO 204 and the DNO 206, and the attribute is secured from modification. That is, neither the DO 204 nor the DNO 206 can modify the attribute directly. However, according to one or more embodiments, the DO 204 and the DNO 206 could re-negotiate the attribute, in which case a new contract token may be issued.

According to one or more embodiments, the DNO 206 causes the token generation service 208 to generate the contract token 214. According to one or more embodiments, a third party other than the DO 204 or the DNO 206 causes the token generation service 208 to generate the contract token 214. In such cases, DNO 206 can retrieve the contract token 214 and the DO 204 can use the contract token 214. The third party can act as a mediator between the DO 204 and the DNO 206. For example, the third party can be a regulatory or auditing entity. The third party generates the contract token 214, the DNO 206 retrieves/views (but not generates) the contract token 214, and the DO 204 uses the contract token 214.

At block 306, the DSS 202 enables the DO 204 to execute an operation (e.g., data operation 218) on the data 201 based at least in part on the contract token 214. If the contract token 214 is not present, is invalid, has expired, and/or the like, including combinations and/or multiples thereof, the DSS 202 prohibits the DO 204 from executing the data operation 218 on the data 201 that is not authorized by the contract token 214 (see, e.g., FIG. 2B).

According to one or more embodiments, the environment 200 can utilize encryption/decryption techniques to validate contract tokens. For example, the token generation service 208 signs the contract token 214 using a private key (e.g., the private key(s) 212) to encrypt the contract token 214. The DSS 202 validates the contract token 214 using a public key (e.g., the public key(s) 220) associated with the private key (e.g., the private key(s) 212) to decrypt the contract token 214.

Additional processes also may be included, and it should be understood that the processes depicted in FIG. 3 represent illustrations, and that other processes may be added or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

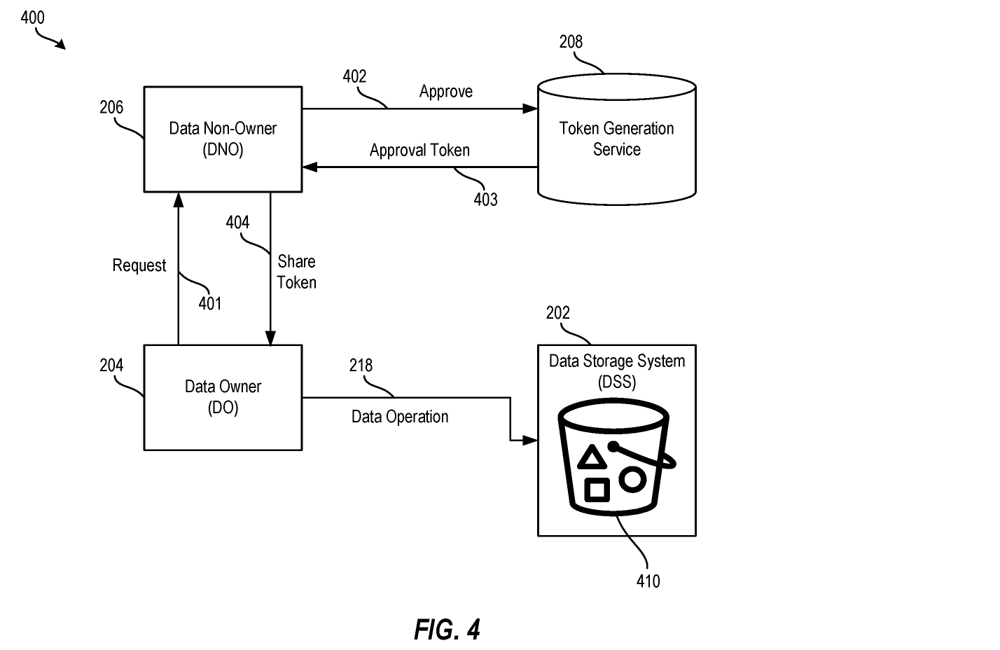

FIG. 4 illustrates a block diagram of an environment 400 for multi-party token-based authorization for a data storage system, according to an embodiment.

The environment 400 enables a protection management workflow to be implemented, which is now described in more detail. In this example, the DO 204 is directly responsible for data stored in the DSS 202. The DO 204, which may be a storage customer, sends a request to shorten retention of data (e.g., the request 401) to the DNO 206, which may be a storage administrator. The DNO 206 reviews the request 401 and determines whether to approve the request 401. If approved, the DNO 206 sends an approval 402 to the token generation service 208 indicating that the DNO 206 grants the DO 204 the ability to put a bucket 410 under “protection management” via a temporary contract token. The bucket 410 represents a protected container for storing protected objects. The token generation service 208 generates an approval token 403 (e.g., the contract token 214), which is sent back to the DNO 206. The DNO 206 then shares the approval token 403 with the DO 204 by performing a share token 404.

Once the DO 204 receives the approval token 403 from the DNO 206 via the share token 404, the DO 218 can initiate the data operation 218. According to one or more embodiments, the data operation 218 proceeds as follows. The DO 204 can put the bucket 410 into the “protection management” state by issuing a request using valid access permissions (e.g., credentials (e.g., username/password) associated with the DO 204) and the approval token 403 from the DNO 206. The DSS 202 validates the approval token 403 and the access permissions for the bucket 410. The DO 204 shortens retention of an object within the bucket 410 that is in the “protection management” state. According to one or more embodiments, objects cannot be deleted while the bucket 410 is in the “protection management” state. When done, the “protection management” state on the bucket 410 is revoked, such as by the DO 204 re-enabling protection on the bucket 410, a time limit defined by the approval token 403 expiring, and/or the like, including combinations and/or multiples thereof.

In this approach, the DO 204 retains ownership of enabling the “protection management” state on the bucket 410 through choice to apply the approval token 403. The DNO 206 is able to temporarily grant ability to the DO 204 where the DO 204 does not otherwise have access/permission.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
receiving, at a token generation service, a contract token request from a data non-owner, the contract token request indicating a condition of an agreement between the data non-owner and a data owner that owns data stored in a data storage system; and
generating, by the token generation service, a contract token based on the contract token request, the contract token including an attribute that defines the condition of the agreement between the data non-owner and the data owner,
wherein the data storage system enables the data owner to execute an operation on the data based at least in part on the contract token.

2. The computer-implemented method of claim 1, wherein the token generation service signs the contract token using a private key to encrypt the contract token.

3. The computer-implemented method of claim 2, wherein the data storage system validates contents of the contract token against alteration using a public key associated with the private key.

4. The computer-implemented method of claim 1, wherein the data owner and the data non-owner communicate via a secure communication channel.

5. The computer-implemented method of claim 1, wherein the data storage system prohibits the data owner from executing the operation on the data that is not authorized by the contract token.

6. The computer-implemented method of claim 1, wherein the attribute is viewable by each of the data owner and the data non-owner, and wherein the attribute is secure from modification.

7. The computer-implemented method of claim 1, wherein the data non-owner causes the token generation service to generate the contract token.

8. The computer-implemented method of claim 1, wherein a third party other than the data non-owner and the data owner causes the token generation service to generate the contract token.

9. The computer-implemented method of claim 8, wherein the data non-owner retrieves the contract token and the data owner uses the contract token.

10. A system comprising:
a memory comprising computer readable instructions; and
a processing device for executing the computer readable instructions, the computer readable instructions controlling the processing device to perform operations comprising:
receiving, at a token generation service, a contract token request from a data non-owner, the contract token request indicating a condition of an agreement between the data non-owner and a data owner that owns data stored in a data storage system; and
generating, by the token generation service, a contract token based on the contract token request, the contract token including an attribute that defines the condition of the agreement between the data non-owner and the data owner,
wherein the data storage system enables the data owner to execute an operation on the data based at least in part on the contract token.

11. The system of claim 10, wherein the token generation service signs the contract token using a private key to encrypt the contract token.

12. The system of claim 11, wherein the data storage system validates contents of the contract token against alteration using a public key associated with the private key.

13. The system of claim 10, wherein the data owner and the data non-owner communicate via a secure communication channel.

14. The system of claim 10, wherein the data storage system prohibits the data owner from executing the operation on the data that is not authorized by the contract token.

15. The system of claim 10, wherein the attribute is viewable by each of the data owner and the data non-owner, and wherein the attribute is secure from modification.

16. The system of claim 10, wherein the data non-owner causes the token generation service to generate the contract token.

17. The system of claim 10, wherein a third party other than the data non-owner and the data owner causes the token generation service to generate the contract token.

18. The system of claim 17, wherein the data non-owner retrieves the contract token and the data owner uses the contract token.

19. A computer program product comprising:
a set of one or more computer-readable storage media;
program instructions, collectively stored in the set of one or more storage media, for causing a processor set to perform the following computer operations:
receiving, at a token generation service, a contract token request from a data non-owner, the contract token request indicating a condition of an agreement between the data non-owner and a data owner that owns data stored in a data storage system; and
generating, by the token generation service, a contract token based on the contract token request, the contract token including an attribute that defines the condition of the agreement between the data non-owner and the data owner,
wherein the data storage system enables the data owner to execute an operation on the data based at least in part on the contract token.

20. The computer program product of claim 19, wherein the token generation service signs the contract token using a private key to encrypt the contract token.
